(19) United States
(12) Patent Application Publication
(10) Pub. No.: US 2007/0215778 A1
(43) Pub. Date: Sep. 20, 2007

(54) SEAT ASSEMBLY HAVING A CARTRIDGE ASSEMBLY

(75) Inventors: Ryan Kadlec, Oak Park, MI (US); Alan M. Wagner, Sterling Heights, MI (US); Neil Goodbred, Northville, MI (US); Thomas M. Rojek, Grand Blanc, MI (US); Jeff Healy, Waterford, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/680,905

(22) Filed: Mar. 1, 2007

Related U.S. Application Data
(60) Provisional application No. 60/778,330, filed on Mar. 2, 2006.

(51) Int. Cl. F16M 13/00

(52) U.S. Cl. 248/429

(57) ABSTRACT

A seat assembly comprising a track assembly and a cartridge assembly. The track assembly is configured to position the seat assembly. The cartridge assembly is disposed at least partially inside the track assembly for dampening motion of the seat assembly.

### CROSS-REFERENCE TO RELATED APPLICATIONS

This application claims the benefit of U.S. provisional application Ser. No. 60/778,330 filed Mar. 2, 2006.

### BACKGROUND OF THE INVENTION

### 1. Field of the Invention

The present invention relates to a seat assembly having a cartridge assembly.

### SUMMARY OF THE INVENTION

In at least one embodiment of the present invention, a seat assembly is provided. The seat assembly may include a track assembly configured to position the seat assembly and a cartridge assembly. The cartridge assembly may be disposed at least partially inside the track assembly and dampen motion of the seat assembly.

In at least one other embodiment of the present invention, a seat assembly is provided. The seat assembly includes a track assembly and a cartridge assembly. The track assembly has an outer track and an inner track received by the outer track. The cartridge assembly has a bracket portion disposed adjacent to the inner track and a cartridge portion having a trigger. The cartridge portion dampens motion of the inner track when the trigger is interlocked with the outer track and sufficient force is provided to move the bracket portion with respect to the cartridge portion.

In at least one other embodiment of the present invention, a seat assembly is provided. The seat assembly may include a track assembly and a cartridge assembly. The track assembly has an inner track and an outer track. The cartridge assembly has a bracket portion and a cartridge portion. The bracket portion is disposed adjacent to the inner track and includes a bracket, a pivot plate moveably coupled to the bracket, and an actuator plate having an elongated slot. The cartridge portion has a block and a trigger. The trigger is moveably received by the block and operatively associated with the actuator plate. The inner track is permitted to move relative to the outer track when the trigger is disengaged from the outer track or when the trigger is engaged with the outer track and the actuator plate moves relative to the trigger.

### BRIEF DESCRIPTION OF THE DRAWINGS

FIG. 1 is a side view of a seat having a track assembly.

FIG. 2 is a perspective view of the track assembly and a cartridge assembly.

FIG. 3 is an exploded perspective view of the track assembly and the cartridge assembly.

FIG. 4 is an exploded perspective view of a portion of the cartridge assembly.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

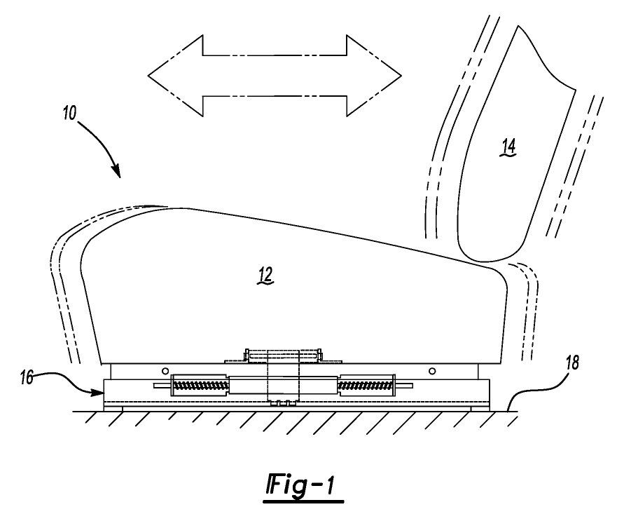

Referring to FIG. 1, an exemplary seat assembly 10 is shown. In at least one embodiment, the seat assembly 10 may be associated with a motor vehicle. The seat assembly 10 may include a seat bottom 12, a seat back 14, and at least one track assembly 16. A track assembly 16 may be coupled to the seat bottom 12 and to a mounting surface 18 to facilitate movement of the seat assembly 10. For example, two track assemblies 16 may be spaced apart and disposed generally parallel to each other to facilitate fore/aft movement of the seat assembly 10 relative to the mounting surface 18 as represented by the double arrow line.

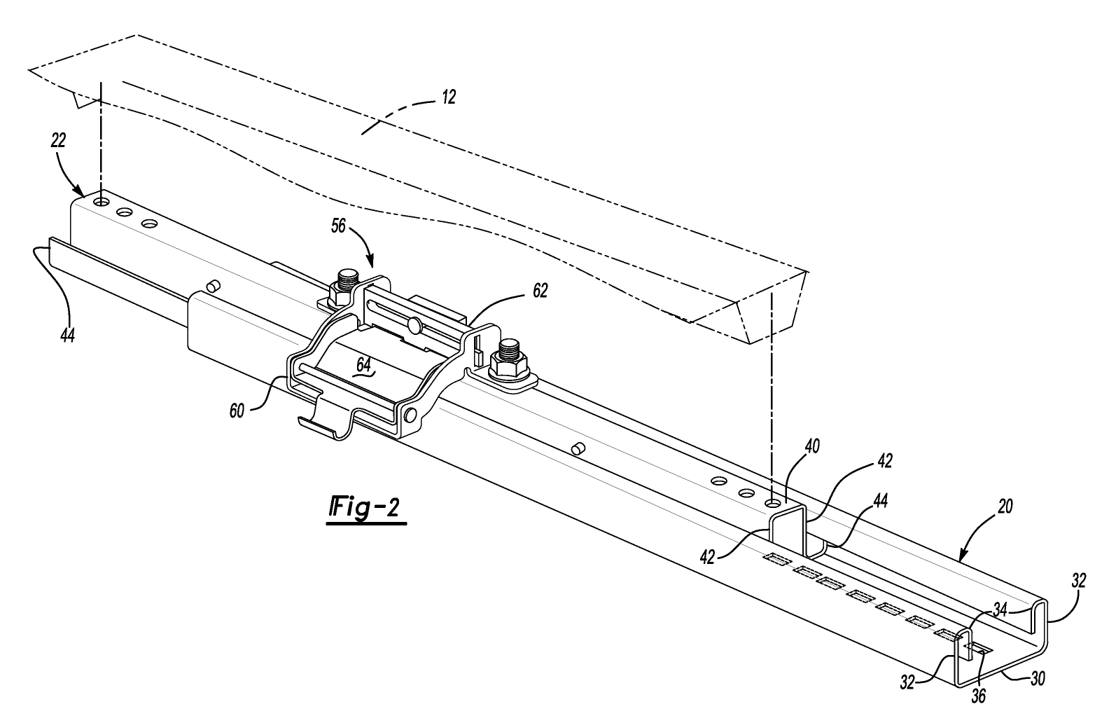

Referring to FIG. 2, a track assembly 16 is shown in more detail. The track assembly 16 may include an outer track 20 and an inner track 22. The inner and outer tracks 20,22 may be made of any suitable material, such as a metal like steel.

The outer track 20 may be fixedly positioned relative to the mounting surface 18. The outer track 20 may have any suitable configuration. In at least one embodiment, the outer track 20 may have generally U-shaped cross section and may include a bottom wall 30 and opposing side walls 32 that may extend from the bottom wall 30. The side walls 32 may each include a hook portion 34. The hook portions 34 may face inwardly and may extend generally toward the bottom wall 30. The bottom wall 30 may include a plurality of apertures 36. The apertures 36 may be spaced apart from each other and may have any suitable configuration. For instance, the apertures 36 may be generally rectangular and may be generally disposed along the length of the bottom wall 30.

The inner track 22 may be received by and may be adapted to move relative to the outer track 20. The inner track 22 may have any suitable configuration. In at least one embodiment, the inner track 22 may include a top wall 40 and opposing side walls 42 that may extend from the top wall 40. The side walls 42 may each include a hook portion 44. The hook portions 44 may face outwardly and may extend generally toward the top wall 40. The hook portions 44 of the inner track 22 may cooperate with the hook portions 34 of the outer track 20 to permit fore/aft movement of the inner track 22 relative to the outer track 20 while inhibiting the inner track 22 from lifting out of the outer track 20.

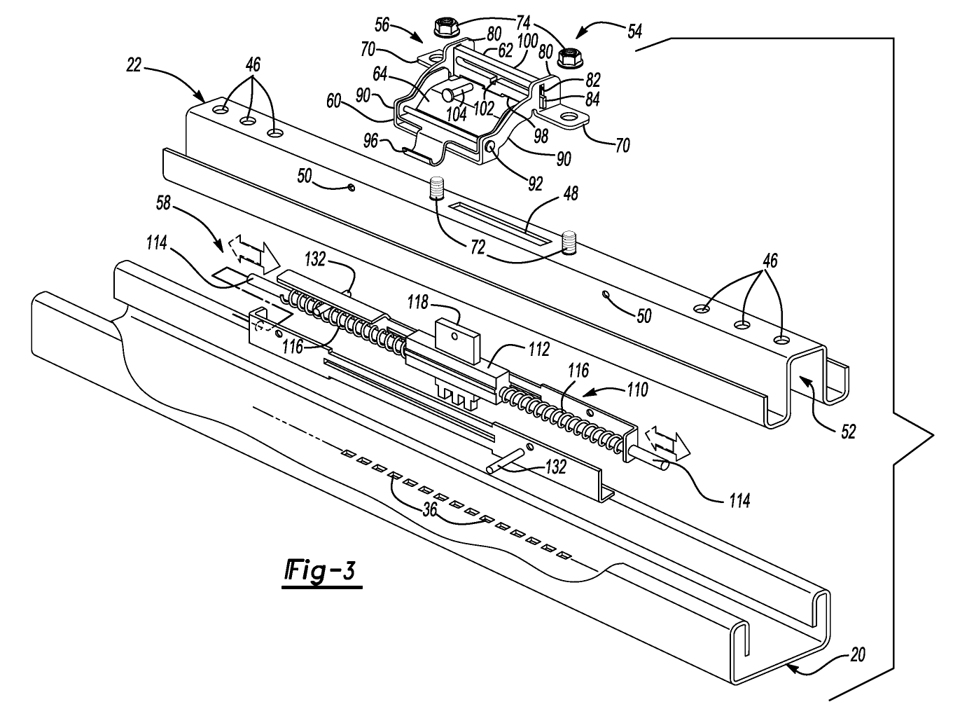

Referring to FIG. 3, additional attributes that may be associated with the inner track 22 are shown. For example, the top wall 40 of the inner track 22 may include one or more mounting points 46 that facilitate attachment of the seat bottom 12. The top wall may also include a slot 48. The side walls 42 may include holes 50 that are adapted to receive a fastener as will be described in more detail below. In addition, top and side walls 40,42 may also at least partially define a cavity 52 for receiving at least a portion of a cartridge assembly 54.

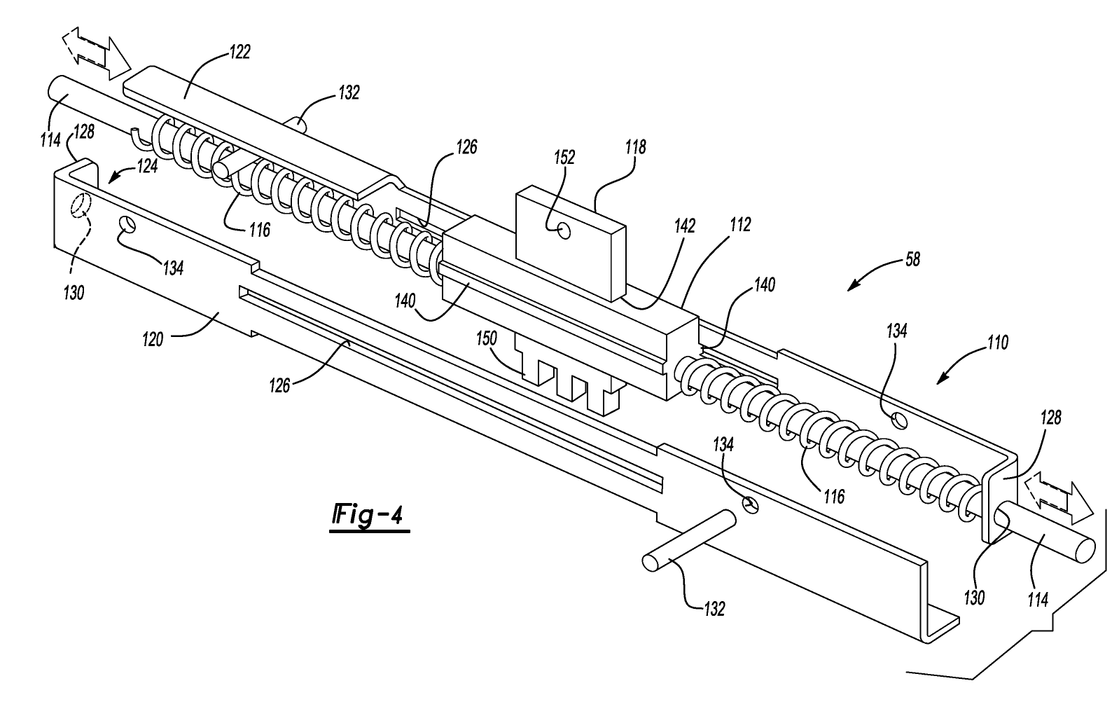

Referring to FIGS. 3 and 4, an exemplary cartridge assembly 54 is shown in more detail. The cartridge assembly 54 may allow the seat assembly 10 to move in a fore/aft direction to help isolate a seat occupant from repetitive lunging and to improve occupant comfort as will be described in more detail below. In addition, the cartridge assembly 54 may help absorb load forces associated with a vehicle impact event to help improve occupant safety in one or more embodiments of the present invention. The cartridge assembly 54 may include a bracket portion 56 and a cartridge portion 58. Components that comprise the bracket and cartridge portions 56,58 may be made of any suitable materials, such as one or more metals, and may be fabricated in a manner known by those skilled in the art.

The bracket portion 56 may be adapted to be mounted to the inner track 22. In at least one embodiment, the bracket portion 56 may include a mounting bracket 60, an actuator plate 62, and a pivot plate 64.

The mounting bracket 60 may be adapted to be mounted to the inner track 22 in any suitable manner. For example, the mounting bracket 60 may include at least one mounting flange 70 that facilitates mounting to the top wall 40. In at least one embodiment, the mounting flange 70 may receive a fastener 72, such as a stud, that may be mounted to the inner track 22. A nut 74 may engage the fastener 72 to secure the mounting bracket 60 to the inner track 22 in one or more embodiments of the present invention.

The mounting bracket 60 may also include at least one guide flange 80 that may receive and guide movement of the actuator plate 62. The guide flange 80 may be disposed proximate the mounting flange 70. In addition, the guide flange 80 may include a slot 82 that receives a portion of the actuator plate 62, such as a tab 84, to enable limited movement of the actuator plate 62 relative to the mounting bracket 60. In at least one embodiment, the slot 82 may be generally linear and may be configured allow the actuator plate 62 to move toward or away from the inner track 22.

The mounting bracket 60 may also be adapted to receive the pivot plate 64. In at least one embodiment, the mounting bracket 60 may include at least one support arm 90 that pivotally receives the pivot plate 64. The support arm 90 may be disposed proximate the mounting flange 70 and/or guide flange 80 and extend to a side of the track assembly 16. The pivot plate 64 may be pivotally disposed on the support arm 90 in any suitable manner, such as with a pin 92. Moreover, the mounting bracket 60 and pivot plate 64 may be oriented to face toward the center of the seat assembly 10 so that these features are concealed under the seat bottom 12.

The pivot plate 64 may include a first end 96 and a second end 98. The second end 98 may be disposed between the mounting bracket 60 and/or inner track 22 and the actuator plate 62. The first end 90 may be associated with an actuator, such as a handle that is moveably disposed on the seat assembly 10. As such, force applied via the actuator may be transmitted to the first end 96 to actuate or pivot the pivot plate 64. For instance, downward force on the first end 96 may cause the second end 98 to move away from the inner track 22, thereby lifting the actuator plate 62.

The actuator plate 62 may include an elongated slot 100 that may generally extend parallel to the inner track 22. The elongated slot 100 may be generally disposed between the guide flanges 80 in one or more embodiments of the present invention. The elongated slot 100 may include a detent notch 102. The detent notch 102 may extend toward the inner track 22 and may be disposed in any suitable location, such as near the center of the elongated slot 100. The elongated slot 100 may receive a fastener 104, such as a pin, that facilitates operation of the cartridge portion 58 as will be discussed in more detail below.

Referring to FIGS. 3 and 4, an exemplary cartridge portion 58 is shown in more detail. The cartridge portion 58 may include a housing 110, a block 112, a rod 114, a spring 116, and a trigger 118.

The housing 110 may have any suitable configuration. For example, the housing 110 may include one or more parts, such as a first part 120 and a second part 122, to facilitate assembly. In at least one embodiment, the first and second parts 120,122 may be generally configured as inverted mirror images of each other. The housing 110 may at least partially define a chamber 124. In addition, the housing 110 may include at least one alignment feature 126 and opposing end walls 128. The alignment feature 126 may have any suitable configuration, such as a male or female configuration, and may extend along at least one side of the housing 110. The end walls 128 may each include a hole 130 adapted to receive a rod 114. In addition, a bushing may be disposed in the hole 130 to receive and guide an associated rod 114 in at least one embodiment of the present invention.

The housing 110 may be adapted to be coupled to the inner track 22. For instance, the housing 110 may be disposed in the cavity 52 in the inner track 22 and coupled to the inner track 22 in any suitable manner. For instance, a fastener 132, such as a roll pin, may extend through at least one hole 50 in the inner track 22 and at least one hole 134 in the housing 110 to fixedly couple the housing 110 to the inner track 22. The fastener 132 and hole 134 may be spaced apart from the rod 114 and spring 116 so as not to interfere with their operation.

The block 112 may be moveably disposed in the housing 110. For example, at least a portion of the block 112 may be disposed in the chamber 124 and may be adapted to slide in a direction extending generally between the end walls 128. The block 112 may have any suitable configuration. In at least one embodiment, the block 112 may include an alignment feature 140 that cooperates with the alignment feature 126 on the housing 110 to help position the block 112. In addition, the block 112 may include a slot 142 that receives the trigger 118. The slot 142 may generally be disposed perpendicular to the block 112 and/or the fore/aft direction of movement in at least one embodiment of the present invention. In addition, the slot 142 may permit movement of the trigger 118 toward or away from the outer track 20 while inhibiting movement of the trigger 118 relative to the block 112 in one or more other directions.

At least one rod 114 may be fixedly coupled to and extend from the block 112. In the embodiment shown, the rod 114 extends from opposing end walls 128 of the block 112. The rod 114 may be supported by the housing 110 and/or the track assembly 16 throughout its range of travel in the direction represented by the double arrow lines in at least one embodiment of the present invention.

At least one spring 116 may be associated with the rod 114. In the embodiment shown in FIG. 4, two springs 116 are provided. Each spring 116 may be disposed around the rod 114 and may be disposed between an end wall 128 of the housing 110 and the block 112. The springs 116 may react to movement of the vehicle and/or load forces to help isolate or dampen motion of a seat occupant as will be discussed in more detail below. In addition, the springs 116 may be designed to provide a biasing force that limits movement of the block 112 to targeted design amount. In one exemplary embodiment, the springs 116 may be configured to restrict movement to approximately 6 cm or less to enhance occupant comfort.

The trigger 118 may extend through the inner track 22, the housing 110, and the slot 142 in the block 112. The trigger 118 may have any suitable configuration. For instance, the trigger 118 may include at least one tooth 150 that may be adapted to engage a slot 36 in the outer track 20. A plurality of teeth may be provided to help distribute load forces and/or provide anti-chucking features to facilitate smooth engagement and disengagement of the trigger 118 from the outer track 20. The tooth or teeth may be arranged in any suitable fashion. For example, teeth may be provided in a coplanar arrangement and may extend at any suitable angle that is compatible with the slots 36 in the outer track 20.

The trigger 118 may be operatively associated with the actuator plate 62. For instance, the trigger 118 may be connected to the actuator plate 62 in any suitable manner. In at least one embodiment, the trigger 118 may include a hole 152 adapted to receive the fastener 104 that extends through the elongated slot 100 in the actuator plate 62.

Operation of the track assembly 16 and cartridge assembly 54 in association with the seat assembly 10 will now be described in more detail. For convenience, operation will be described with respect to the embodiment and components shown in the figures.

First, the seat assembly 10 may be slid to a desired fore/aft location by positioning the inner track 22 relative to the outer track 20. The inner track 22 may be positioned relative to the outer track 20 when the trigger 118 is disengaged from the outer track 20. The trigger 118 may be disengaged from the outer track 22 when sufficient force is exerted on the pivot plate 64 to lift the actuator plate 62 and the trigger 118. Similarly, the inner track 22 may be fixedly positioned with respect to the outer track 20 when the trigger 118 and the outer track 20 are engaged.

Second, the cartridge assembly 54 may be activated to help isolate a seat occupant from vehicle motion and/or load forces when the trigger 118 and the outer track 20 are engaged. The cartridge assembly 54 may be in an activated state when the pin 104 is permitted to move in the elongated slot 100. For instance, the pin 104 may be permitted to move in the elongated slot 100 when motion forces are sufficient to disengage the pin 104 from the detent notch 102. As such, the inner track 22 may be permitted to move over a limited distance relative to the outer track 20 as represented by the double arrow lines in FIGS. 1 and 4. More specifically, the cartridge assembly 54 may be configured to provide a controlled or limited amount of movement to dampen forces, such as those associated with vehicle motion or vibration. The block 112 and rod 114 remain stationary with respect to the outer track 20 when the trigger 118 and outer track 20 are engaged. The housing 110 is permitted to slide along the rod 114 when sufficient force is transmitted to overcome the biasing force of the springs 116 and the pin 104 is disengaged from the detent notch 102. Movement of the housing 110 (and the inner track 22 which is fixedly coupled to the housing 110) is dampened by the springs 116. The dampening effects of the cartridge assembly 54 may be deactivated when the pin 104 is disposed in the detent notch 102. As such, the detent notch 102 captures the pin 104 to inhibit movement of the housing 110 and inner track 22 relative to the outer track 20.

In at least one embodiment of the present invention, occupant comfort may be improved and fatigue may be reduced. In addition to occupant-related benefits, disposing the cartridge assembly between the outer and inner tracks may reduce package space and help protect cartridge components. Moreover, outer and inner tracks may also be standardized so that they may be used with different seat designs that may be provided with or without a cartridge assembly. Similarly, the mechanisms used to release the inner track from the outer track for positioning the seat assembly may be standardized on one or more embodiments of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seat assembly comprising:
a track assembly configured to position the seat assembly; and
a cartridge assembly disposed at least partially inside the track assembly for dampening motion of the seat assembly.

2. The seat assembly of claim 1 wherein the track assembly further comprises an outer track and an inner track received by the outer track, wherein the cartridge assembly is at least partially disposed between the inner and outer tracks.

3. The seat assembly of claim 1 wherein the cartridge assembly further comprises a bracket portion mounted to the track assembly and a cartridge portion disposed at least partially inside the track assembly.

4. The seat assembly of claim 3 wherein the cartridge portion further comprises a spring disposed inside the track assembly that provides a biasing force for dampening movement of the seat assembly.

5. The seat assembly of claim 3 wherein the bracket portion further comprises an actuator plate and the cartridge portion further comprises a trigger, wherein the actuator plate is operatively associated with the trigger to engage or disengage the trigger from the track assembly.

6. The seat assembly of claim 5 wherein the actuator plate further comprises an elongated slot that permits at least a portion of the track assembly to move relative to the trigger.

7. The seat assembly of claim 6 wherein the elongated slot further comprises a detent notch, wherein the movement of the track assembly is inhibited when the trigger is coupled to the detent notch.

8. A seat assembly comprising:
a track assembly having an outer track and an inner track received by the outer track; and
a cartridge assembly having a bracket portion disposed adjacent to the inner track and a cartridge portion having a trigger;
wherein the cartridge portion dampens motion of the inner track when the trigger is interlocked with the outer track and sufficient force is provided to move the bracket portion with respect to the cartridge portion.

9. The seat assembly of claim 8 wherein the cartridge portion further comprises a housing fixedly coupled to the inner track.

10. The seat assembly of claim 9 wherein the cartridge portion further comprises a block disposed in and adapted to move relative to the housing.

11. The seat assembly of claim 10 wherein the block further comprises a slot that receives a trigger.

12. The seat assembly of claim 10 wherein the cartridge portion further comprises a rod that extends from the block and through a hole in an end wall of the housing.

13. The seat assembly of claim 12 wherein the cartridge portion further comprises a spring disposed between the block and the end wall for providing a biasing force to dampen motion of the inner track.

14. The seat assembly of claim 13 wherein the spring is disposed about the rod.

15. The seat assembly of claim 10 wherein the inner track includes an inner track slot that receives the trigger, wherein the inner track slot is configured to allow the inner track to move about the trigger when the trigger engages the outer track.

16. A seat assembly comprising:
a track assembly having an inner track and an outer track; and
a cartridge assembly including:
a bracket portion disposed adjacent to the inner track, the bracket portion including a bracket, a pivot plate moveably coupled to the bracket, and an actuator plate having an elongated slot; and
a cartridge portion having a block and a trigger moveably received by the block and operatively associated with the actuator plate;
wherein the inner track is permitted to move relative to the outer track when the trigger is disengaged from the outer track or when the trigger is engaged with the outer track and the actuator plate moves relative to the trigger.

17. The seat assembly of claim 16 wherein the bracket further comprises a guide flange having an opening for moveably receiving the actuator plate, wherein the actuator plate moves within the opening when actuated by the pivot plate.

18. The seat assembly of claim 16 further comprising a pin that extends through the elongated slot and is fixedly coupled to the trigger.

19. The seat assembly of claim 18 wherein the cartridge assembly further comprises a housing disposed in the inner track, a rod extending from the block through a hole in the housing, and a spring disposed around the rod for providing a biasing force to dampen movement of the seat when the pin moves within the elongated slot.

20. The seat assembly of claim 18 wherein the elongated slot includes a detent notch, wherein dampening operation of the cartridge assembly is deactivated when the pin is disposed in the detent notch.
